(19) United States
(12) Patent Application Publication
(10) Pub. No.: US 2012/0187872 A1
(43) Pub. Date: Jul. 26, 2012

(54) SYSTEM TO IMPROVE FUEL ECONOMY AND REDUCE A PLURALITY OF TOXIC GAS EMISSIONS IN A MOTORIZED VEHICLE THROUGH UTILIZING ENERGY CONTAINED IN A QUANTUM VACUUM

(76) Inventor: Aida Camacho de Bermúdez, La Paz (BO)

(21) Appl. No.: 13/357,079

(22) Filed: Jan. 24, 2012

Related U.S. Application Data
(60) Provisional application No. 61/436,152, filed on Jan. 25, 2011.

(51) Int. Cl. H05H 9/00

(52) U.S. Cl. 315/505

(57) ABSTRACT

The present invention is a system to improve fuel economy of a vehicle with an internal combustion engine or an electric engine. The system includes a base, a primary energy absorption mechanism to attract and store energy contained in a quantum vacuum and a plurality of fasteners that are utilized to removably secure the system to the vehicle hood or the electrical engine. The system also includes a pair of hybrid ceramic magnets that are disposed within the primary energy absorption mechanism, a pair of metal plates and a linear particle accelerator that has variable field strength and is positioned within the primary energy absorption mechanism that includes a signal transmitter.

This application claims priority to U.S. Provisional Application 61/436,152 filed on Jan. 25, 2011, the entire disclosure of which is incorporated by reference.

### TECHNICAL FIELD & BACKGROUND

Quantum or primary particle energy has been known as the Aether, the Fermi Sea, the Dirac Sea, radiant energy, orgone, the quantum magnetic of the vacuum, the quantum vacuum and, more recently, the zero point of the vacuum. In order to explain what this energy system actually is, it will be necessary to give an explanation of the physics associated with the vacuum. Considering that the vacuum of classical physics denotes empty space, in quantum physics the term represents the lowest energy and greatest stability or ground state of a system. Although the correct name for this system is the quantum magnetic of the vacuum or the quantum vacuum, it is more popularly known as the zero point as it has been demonstrated, by Harold Puthoff and others, to exist even at absolute zero. In quantum field theory, all fields and particles are treated as different excitation states of a vacuum field and this forms the basis for the conceptual theory.

Every type of field or particle will have its own vacuum state. In this state, the electromagnetic field still possesses residual energy, due to the Heisenberg Indeterminacy Principle, which is known as zero point energy and indicated by zero point fluctuations. This also applies to the vacuum states of other physical fields and particles. In other words, the apparently empty space in which all matter fields have average zero point intensity is in reality filled with the ceaseless activity of quantum particles and fields which normally go in and out of existence in extremely short lifetimes measured in nanoseconds. However, under certain conditions, these particles and fields can materialize in a much more stable manner as demonstrated in nature on a daily basis throughout the universe. The vacuum may therefore be considered to be the interface between a fundamental region of pre-physical potentiality and the region of physical reality in which the processes of material manifestation take place. A comprehension of the electromagnetic vacuum is indispensable in order to understand the associated quantum mechanics. This principle and the required comprehension of the same will open the way to an understanding of how nature condenses energy into matter in a stable manner and also how this energy may be extracted in order to satisfy the world's energy demands.

However, it is not sufficient to take into account only the effects of the electromagnetic vacuum, such as the Casimir Effect, but the unified field of all physical forces whose vacuum constitutes the real primordial base of the physical world is what must be considered. This fundamental vacuum is a field that is composed of quantum or primary energy particles that saturates the entire universe and forms the matrix of all manifestation. It has been compared to a vast ocean from which all manifestation arises and, after such manifestation has run its course, disappears to begin the cycle anew. This energy system, as stated before, is also known as zero point energy and its intensity has been shown to be proportional to the cube of a given frequency acting upon the system as this is the only relationship which is in keeping with quantum mechanics. Credit for the discovery of this system of energy was given to the Dutch physicist M. J. Sparnay in 1958, but there is sufficient evidence to allow for the awarding of this achievement to Nicola Tesla due to his work with radiant energy which occurred at an earlier time. Feynman and Wheeler calculated that a volume of this energy equivalent to that of a coffee cup was sufficient to evaporate all of the world's oceans. In recent publications H. E. Puthoff, B. Haisch and A. Rueda calculated the mass density equivalent of the quantum or zero point fields at 10°97 Kg per M3. Also recently quantum vacuum energy flow was determined to be a function of quantum vacuum energy density and the speed of light.

The mechanics associated with this system lies within the field of non equilibrium statistical mechanics and the first exact derivation of the involved functional was also recently achieved by Derrida, Lebowitz and Speer. This energy includes basic or primary particles which compose the quarks and leptons of quantum physics. Every type of matter, known or theoretical, is or will be formed by the condensation of these particles into the quantum configuration that corresponds to a given type of matter. Therefore, quantum or primary particle energy is the basic building block of which all matter is composed and it has some interesting characteristics. Of these the one which is very pertinent is that it appears to defy the mechanics associated with osmosis which holds that a given material will move from an area of greater concentration to an area of lower concentration until a state of equilibrium has been attained. However, quantum energy is not really governed by this and, therefore, in no way contradicts it. It is actually the law of gravity, as defined by Le Sage, which governs quantum energy or at least this appears to be the case. If we suspend a sphere of some material having a relatively small mass at a fixed distance above the relatively superior mass of the earth, we will be charging the former with an energy potential due to the gravitational attraction between the two masses. If this potential is released, then the smaller mass will be attracted to the larger in a proportion which will accelerate according to the kinematics of falling bodies.

This appears to be the same with quantum or primary particle energy. It appears to move from an area of low concentration to an area of high concentration at a velocity of acceleration which also appears to be governed by the kinematics of falling bodies. The physical scientist will note that this is not an attempt to unify quantum mechanics with gravity in order to form a theory for the unification of fields. The following are concepts, which deal with the functional mechanisms of the quantum or zero point fields. These concepts are the result of more than thirty years of investigation.

1.0—The quantum vacuum is a vast system of energy as shown by Puthoff, Haisch and Rueda.

2.0—Every particle, which is more complex than the most basic primary particle, and the field generated by same will differ in excitation state from that of other particles and fields.

3.0—The quantum vacuum is probably the underlying structure of the known universe.

4.0—The quantum vacuum is a closed system in that all energy taken from it will eventually return to it.

5.0—Any source of molecular, atomic or sub atomic resonance will serve to attract energy from a quantum vacuum field as long as the resonance is greater than that of the quantum vacuum.

6.0—As quantum vacuum energy flow has been shown to be a function of quantum vacuum density and the speed of light, it follows that an artificial enhancement of the native resonance of a given material will have the same effect as increasing density and, thereby, energy flow. This may be accomplished both actively and passively.

7.0—Certain arrangements of organic and inorganic materials provide for a natural attraction of energy from the quantum vacuum. This arrangement of materials can be used to direct the flow of energy from the quantum vacuum and also to store it.

8.0—Inorganic materials, in particular metals, will reflect and or disperse quantum vacuum energy.

9.0—The material sequence of low density organic, medium density inorganic and high density inorganic will serve to attract and store energy from the quantum vacuum. The energy storage capacity of such an arrangement of materials is a function of density and volume.

10.0—Quantum vacuum energy will flow to the point of greatest molecular or sub atomic resonance.

11.0—Quantum vacuum energy is primordial and will adapt to its environment.

12.0—Although the intensity of quantum vacuum energy is proportional to the cube of a given frequency acting on the system, certain frequencies within certain ranges of the quantum vacuum spectrum produce improved energy flow. This could be due to inter dimensional factors.

13.0—The quantum vacuum includes a plurality of longitudinal waves which are composed of alternating concentrations of densified and rarefied pulsations of electrostatic fields moving along a single vector.

14.0—The abrupt discharge of an electrostatic potential of high magnitude and along a single vector will serve to release kinetic energy from the quantum vacuum. This energy release may be significantly increased if the discharged electrostatic potential is of a frequency and pulsed sequence which corresponds with that of a particular part of the upper range of the quantum vacuum field.

15.0—The quantum vacuum plays a role in the manifestations of all electrical theories.

With respect to the absorption of this energy by an electric motor, under normal conditions the rate of absorption is limited to approximately 0.1 per cent of the total energy available. If commercially viable quantities of this energy are to be obtained, then this efficiency of absorption must be significantly increased. This is accomplished through the transmission of a frequency of oscillation which coincides with a particularly effective range of the quantum vacuum and is very close to the native oscillation frequency of the metal copper of which the coil of the motor is composed.

This brings about the photoionization effect in which energy is absorbed by the copper atoms to such an extent that the electrons of these atoms begin to move to progressively higher orbits until they leave the influence of the nucleus as free energy. This liberated energy is continually replaced by incoming energy from the PEAM with the liberated energy being used as extra power for the motor, thereby increasing energy absorption from approximately 0.1 to 18.0 per cent of the total energy available. In conclusion, we are surrounded by an unlimited supply of energy in its primordial or quantum state.

### Josephson Tunneling Mechanism.

The Josephson Effect mechanism is described as an electric current passing between two relatively weakly coupled superconductors which are separated by a thin, insulating barrier. This arrangement is known as a Josephson junction and the current which crosses the barrier is known as the Josephson Current. The two basic equations which govern the involved mechanism are as follows.

The superconducting phase evolution relation is represented by the equation:

$$U ( t ) = \frac{ℏ}{2 e} \frac{\partial φ}{\partial t}$$

The weak link current phase relation is represented by the equation:

I(t)=I_{c} sin(φ(t))

Where U (t) and I (t) respectively represent the voltage and current passing across the Josephson junction, φ (t) is the phase difference across the junction and I_{c} is a constant, known as the critical current of the junction, which can be affected by temperature and an applied magnetic field. The constant h/2e is known as the magnetic flux quantum with its reverse being referred to as the Josephson constant.

The involved mechanism may be further divided into three main effects which are given as follows:

The DC Josephson Effect.

This refers to a direct current passing across the insulator in the absence of an external electromagnetic field due to the tunneling mechanism. This DC current is proportional to the sine of the phase difference across the barrier and may vary between −I_{c} and I_{c}.

The AC Josephson Effect

When a fixed current U_{DC} passes across the junction the phase will vary linearly with time and the current will be alternating with amplitude I_{c} and frequency

$$\frac{2 e}{h} \cdot {U}_{D C} ,$$

with the complete expression for the current becoming:

$${I}_{ext} = {C}_{J} \frac{d v}{d t} + {I}_{J} sin φ + \frac{V}{R}$$

This means that a Josephson junction may act as a perfect voltage to frequency converter.

The Inverse AC Josephson Effect

When the phase of the junction takes the form:

φ(t)=φ₀+nωt+α sin(ωt)

The voltage and current are expressed by:

$$U ( t ) = \frac{ℏ}{2 e} ω ( n + a cos ( ω t ) ) , I ( t ) = {I}_{c} {{\sum }_{m = - ∞}}^{∞} {J}_{n} ( a ) sin ( {φ}_{0} + ( n + m ) ω t )$$

and the DC components are expressed by:

$${U}_{D C} = n \frac{ℏ}{2 e} ω , \\ I ( t ) = {I}_{c} {J}_{- n} ( a ) sin {φ}_{0}$$

This means that, for distinct DC voltages, the junction may carry a DC current and act as a perfect frequency to voltage converter. The DC current is pulsed at a relationship of 10 ms signal on and 10 ms signal off, which has the effect of amplifying the passage of primary energy particles across the barrier represented by the metal of the hood and engine of a vehicle or the metal covering of an electric motor. By way of visualizing this mechanism, if the macroscopic characteristics of the involved metal are looked at, then an apparently solid surface will be seen which presents no possible passage from one side of the structure to the other. However, in the relatively extremely small world of the quantum, the structure of the involved metal at even the atomic level presents gaping holes through which the primary energy particles may pass similar to water through a sieve. This is due to the size of such primary energy particles being an estimated seven orders of magnitude smaller than the nucleus of the hydrogen atom.

In lieu of the described superconductors separated by an insulating barrier, the superconductors are represented by the difference in resonance levels between the PEAM and the internal combustion engine or electric motor. The insulating barrier is represented by the metal of the hood and engine of the vehicle or the covering of the electric motor. As stated previously, if the difference in sub atomic resonance is sufficiently great, then primary particle energy will pass from the PEAM across the metal barrier and into the combustion chambers of the internal combustion engine of the vehicle or into the coil of the electric motor.

The present invention deals with a system for improving the fuel economy of motorized vehicles and reducing toxic gas emissions. The present invention may also be used with electric motors in order to significantly reduce direct energy requirements. This is accomplished through a two part system which is described in the following subsequent overall system.

Most previous efforts for improving fuel economy, engine performance and reducing toxic gas emissions have been aimed at direct improvements to the engine or the fossil fuel utilized by the engine. The present invention constitutes an effort to achieve such improvements through the use of energy contained in a quantum vacuum within the engine. In the case of electric motors the present invention extracts commercially viable quantities of energy from the quantum dynamic energy system of the quantum vacuum. The present invention may be readily industrialized at a relatively modest cost and would serve to address two serious problems which are climate change and the high cost of energy. These problems are favorably addressed through a substantial reduction in fossil fuel consumption and toxic gas emissions. This is especially true if the present invention is used to entirely replace an internal combustion engine with an electric motor.

### SUMMARY OF THE INVENTION

The present invention is a system that improves fuel economy and reduces toxic gas emissions in motorized vehicles through the use of a primary energy absorption mechanism or PEAM which, due to its construction, allows for the attraction and storage of significant amounts of energy contained in a quantum vacuum for subsequent transmission to within an engine compartment and from the engine compartment to the combustion chambers of the engine. The mechanism which governs a release of energy from the primary energy absorption mechanism to the engine compartment and the engine itself depends on the level of molecular resonance produced by the PEAM and the engine when operating. As any source of molecular or sub atomic resonance will serve to attract energy from the quantum vacuum, both the PEAM and any internal combustion engine or electric motor will produce a level of resonance sufficient to allow for such attraction of energy to occur. In order to ensure that the energy attracted and stored by the PEAM will be released into the engine compartment for subsequent absorption by the engine, the level of molecular resonance of the engine or motor when in operation must be substantially greater than that of the PEAM. In order to determine if the difference in resonance levels of the PEAM and the engine or motor is sufficiently great to allow energy release from the PEAM to occur, a simple calculation is used to determine a factor of resonance (RF) of the PEAM and the engine in order to determine if the difference in resonance levels is sufficient to allow for such energy release to occur. The calculation must show at least a ten to one difference between the PEAM and the engine or motor in order to ensure that energy release from the PEAM to the engine or motor will occur. The calculation for determining the difference in resonance level is shown below:

RF=F×P

### Where RF=Level of Resonance, F=Frequency of Oscillation in MHz and P=Potential in Watts.

As an example of the use of this calculation an internal combustion engine composed of cast iron and operating at a potential of 12 volts and 60 amperes is utilized. As the frequency of oscillation of Iron is 103.5 MHz, the following calculation can be made in order to determine the RF of the engine:

RF=103.5×(12×60)

RF=74520

As the PEAM prototype model operates with an RF of 729.9, the ratio between this RF and that of the example above is found as follows:

Engine RF/PEAM RF=7420/729.9=102.096.

As the difference in resonance levels calculated is greater than the ten to one minimum required, energy release from the PEAM to the engine compartment will occur. The energy released by the PEAM first enters into the engine compartment and then into the combustion chambers of the engine display where there is the greatest amount of molecular and subatomic resonance. This is accomplished through a mechanism similar to that of the Josephson Effect previously discussed. Once the energy has entered into the confines of the combustion chambers it is transformed into the fossil fuel being utilized, or something similar, as well as oxygen.

The use of the primary energy absorption mechanism for the transmission of energy from the quantum vacuum to any internal combustion engine or electric motor allows for an improvement in fuel economy along with a reduction in toxic gas emissions. This is supported by field testing data for a plurality of prototypes of the system. The system may be installed on any type of motorized vehicle regardless of the type of fuel utilized and may also be installed on electrically powered vehicles thereby eliminating the need for large banks of batteries along with the need for regular recharging of batteries. The commercial system as applied to the internal combustion engine will be suitable for industrial scale manufacture and is of relatively low cost. The system may also be installed on electric motors used to power electrical generators for use in the production of electrical energy on a relatively small or industrial scale.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an overhead perspective view of a system to improve fuel economy, in accordance with one embodiment of the present invention.

FIG. 1B illustrates a cross-sectional view along line 1-1 of FIG. 1 of a system to improve fuel economy, in accordance with one embodiment of the present invention.

FIG. 1C illustrates a side perspective view of a wiring diagram of a system to improve fuel economy, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase in one embodiment is utilized repeatedly. The phrase generally does not refer to the same embodiment, however, it may. The terms comprising, having and including are synonymous, unless the context dictates otherwise.

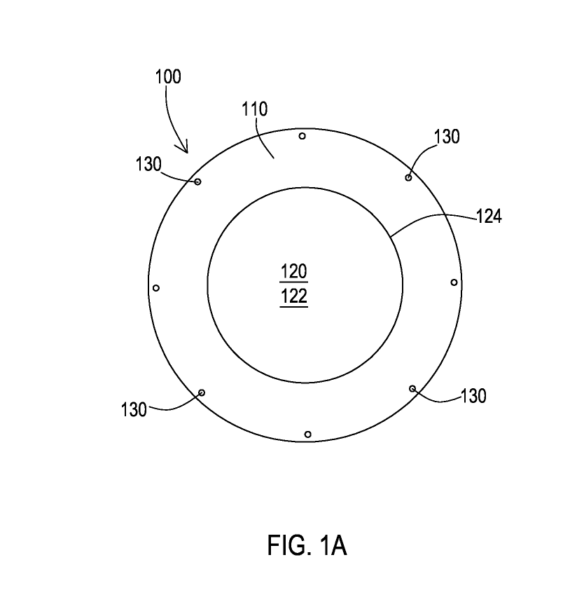

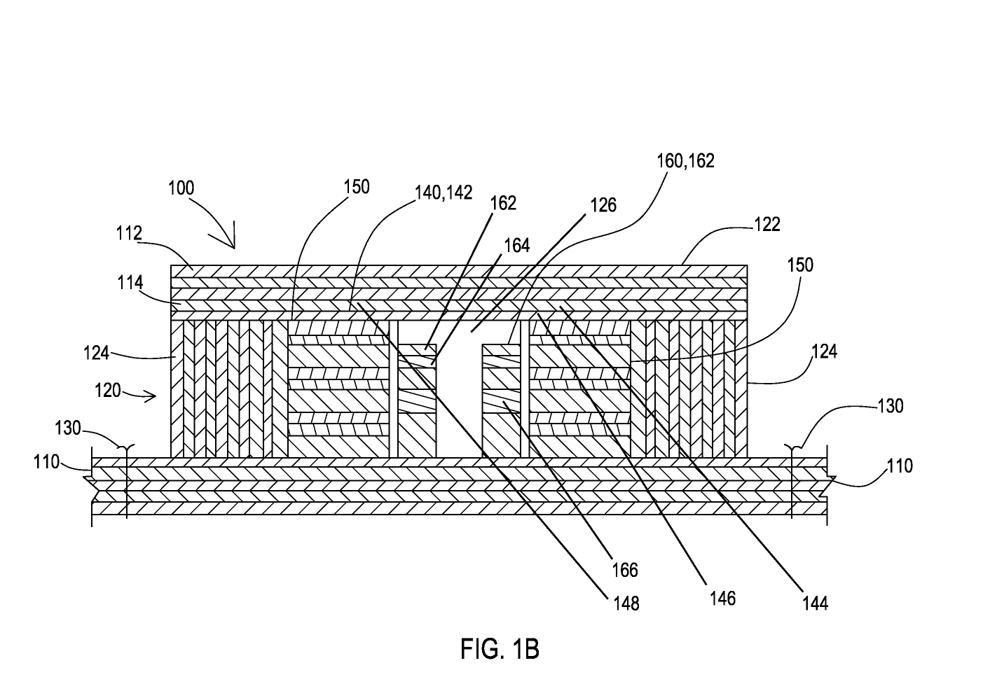

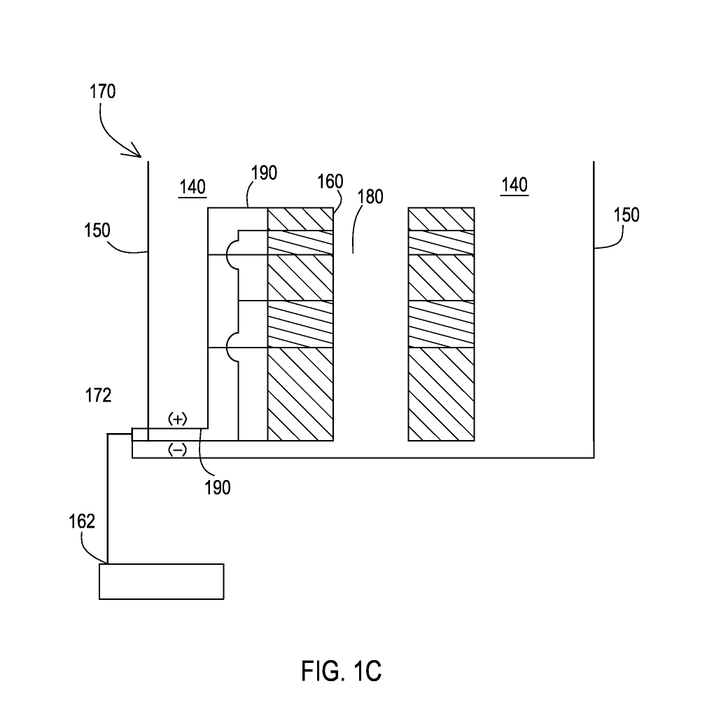

FIG. 1A illustrates an overhead perspective view of a system 100 to improve fuel economy, in accordance with one embodiment of the present invention. The system 100 is typically placed on a hood of a vehicle with an internal combustion engine (not shown) which allows energy attracted and absorbed by the system 100 to pass into a plurality of confines of the internal combustion engine and then be absorbed by the internal combustion engine in a plurality of combustion chambers of the internal combustion engine. The system 100 is typically attached to a vehicle with an electric engine with suitable conductive glue or a plurality of removable fasteners applied directly on the electric engine securing the system directly to the electric engine.

The system 100 includes a base 110, a primary energy absorption mechanism (PEAM) 120 and a plurality of fasteners 130. The base 110 is typically disposed on the vehicle hood of an internal combustion engine or secured on an electric engine of a vehicle with an electric engine with suitable conductive glue. The PEAM 120 is disposed on the base 110 and is the main component of the system 100. The PEAM 120 includes a circular top 122 and a cylindrical inner wall 124. The PEAM 120 is utilized for attraction and storage of energy contained in a quantum vacuum for subsequent transmission to within the confines of the compartment of the engine or electric motor of a motorized vehicle. Further details regarding the PEAM 120 are provided in FIG. 1B. The fasteners 130 are utilized to removably secure the system 100 to a vehicle hood of an internal combustion engine and can also be utilized to secure the system 100 directly to an electric motor as well. The fasteners 130 can be a suitable removable screw, bolt, rivet or other suitable fastener.

FIG. 1B illustrates a cross-sectional view along line 1A-1A of FIG. 1A of a system 100 to improve fuel economy, in accordance with one embodiment of the present invention.

The system 100 includes the base 110, the primary energy absorption mechanism (PEAM) 120 and the plurality of fasteners 130 previously described and illustrated in FIG. 1A and its descriptions. The base 110 is made of a sequential alternating layer of cardboard, STYROFOAM™ or foam rubber 112 and steel wool 114 and can be any suitable number of sequential alternating layers. Any suitable type or grade of cardboard, STYROFOAM™ or foam rubber and steel wool can be utilized to form the suitable number of sequential alternating layers. The circular top 122 and the cylindrical inner wall 124 of the PEAM 120 are also made of a sequential alternating layer of cardboard, STYROFOAM™ or foam rubber and steel wool and can be any suitable number of sequential alternating layers. Any suitable type or grade of cardboard, STYROFOAM™ or foam rubber and steel wool can be utilized to form the suitable number of sequential alternating layers.

The system 100 additionally includes a pair of hybrid ceramic magnets 140, a pair of metal plates 150 and a linear particle accelerator 160. The hybrid ceramic magnets 140 as illustrated in FIG. 1B are a series of three hybrid ceramic magnet plates 142 that are disposed within the PEAM 120. The hybrid ceramic magnets 140 are made of a plurality of sequential alternating layers of plastic resin 144, steel wool 146 and steel powder 148 and can be any suitable number of sequential alternating layers. The pair of metal plates 150 is semi-circular and is disposed between the cylindrical inner wall 124 of the PEAM 120 and the hybrid ceramic magnets 140. The metal plates 150 coincide with the frequency of oscillation which corresponds with a particular range of the quantum vacuum spectrum. This allows for the attraction and absorption of a small but still significant amount of energy from the spectrum. The linear particle accelerator 160 has variable field strength and is positioned within the center of the PEAM 120. The linear particle accelerator 160 is an active and passive linear particle accelerator. A signal transmitter 162 which is connected to the linear particle accelerator 160 located within the core 126 of the PEAM 120 and to the two metal plates 150 attached to the exterior of the core 126 with a suitable coaxial cable (not shown). The signal transmitted to the linear particle accelerator 160 and the metal plates 150 coincides with the frequency of oscillation which corresponds with a particular range of the quantum vacuum spectrum. The linear particle accelerator 160 is made of a plurality of sequential alternating layers of wood 164 and steel 166 and can be any suitable number of sequential alternating layers. This allows for the attraction and absorption of a relatively small but still significant amount of energy from the spectrum. The attracted and absorbed energy is discharged from the PEAM 120 to the engine or electric motor compartment, when the engine or motor is in operation, and from there to the combustion chambers or coil of same thereby allowing for the energy contained in the quantum vacuum to be utilized as an additional power source for the engine or motor. In the case of an electric motor, the energy is discharged from the PEAM 120 and absorbed by a coil of the electric motor where it is converted into electrical energy.

The overall system includes a primary energy absorption mechanism (PEAM) for the attraction and storage of energy contained in a quantum vacuum for subsequent transmission to within the confines of the compartment of an engine or an electric motor of a motorized vehicle. The mechanism includes a suitable linear particle accelerator having a variable field strength that is positioned within the center of the mechanism, a series of three hybrid ceramic permanent magnet plates which are centered on the particle accelerator and a signal transmitter which is connected to the particle accelerator, located within the core of the primary energy absorption mechanism and to two metal plates attached to the exterior of the core with a suitable coaxial cable. The signal transmitted to the particle accelerator and the metal plates coincides with a frequency of oscillation which corresponds with a particular range of the quantum vacuum spectrum. This allows for the attraction and absorption of a small but still significant amount of energy from the spectrum. The attracted and absorbed energy is discharged from the primary energy absorption mechanism to the engine or electric motor compartment, when the engine or motor is in operation and from there to the combustion chambers or coil of the PEAM allowing for the energy contained in the quantum vacuum to be utilized as an additional power source for the engine or motor. In the case of an electric motor, the energy is discharged from the primary energy absorption mechanism and absorbed by the coil of the motor where it is converted into electrical energy.

The PEAM is surrounded by alternating layers of organic and inorganic materials having a sequence of organic material, inorganic material and organic material. The PEAM is attached to the exterior of the vehicle hood or motor cover with a suitable fastener or conductive glue and positioned over the engine or coil. The construction of the particle accelerator, the permanent magnet plates and the overall mechanism is detailed in subsequent figures and descriptions. The accompanying field test data will demonstrate the relative effectiveness of the present invention with respect to the previous features. The present invention is intended to be installed on an existing motorized vehicle or electric motor but it may also be installed on a new vehicle employing an internal combustion engine or an electrically powered vehicle. The present invention may also find use in electrical power generation facilities and marine, air and ground transportation.

The present invention involves a system for producing the attraction and storage of a small but significant amount of energy contained in a quantum vacuum for subsequent release into an engine compartment of a motorized vehicle or the interior of an electric motor. The following subsequent trials will show that any source of resonance will attract energy from the quantum vacuum, any engine or motor when running will serve as a strong source of the resonance and serve to attract energy. However, the trials have also shown that only very little of the attracted energy will enter into the engine or motor since the hood over the engine compartment or the coil of the motor is normally made of some metal which limits the entrance of quantum vacuum energy due to reflection and dispersion. As a result, the majority of the energy attracted by the engine or motor, when in operation, is absorbed by the earth instead.

The primary energy absorption mechanism is placed on the hood of a vehicle which allows the energy attracted and absorbed by the PEAM to first pass into the confines of the engine compartment and then be absorbed by the engine, in the engine's combustion chambers. This allows for the absorbed energy to be utilized by the engine as an alternative fuel source. This is true since the energy contained in the quantum vacuum is primordial and will adapt to a new environment. The new environment is the combustion chambers of an engine where a specific fuel is being combusted in the presence of oxygen, the incoming energy will adapt to this environment and be transformed into the fuel source, or something similar, being used by the engine while in operation as stated before. Also, the energy entering the combustion chambers will serve to activate the molecules of the fuel being combusted to allow for a more through mixing with air which promotes more complete combustion. The results of the field testing of the prototypes of this system have indicated that the engine partially utilizes quantum vacuum energy instead of oxygen in order to achieve combustion. The system may be constructed as an active mechanism which involves a signal transmitter, as a passive mechanism which involves the use of permanent magnets for the particle accelerator in lieu of the transmitter activated coils or as a combination of these two systems.

The construction of the prototype of the active mechanism includes a type of linear particle accelerator, having field strength of 6304 Gauss which is located at the center of the device and enclosed within a tube of PVC material. This accelerator serves to enhance the flow of energy from the quantum vacuum to within the engine compartment of the vehicle. The tube which contains the accelerator is surrounded by a series of three hybrid ceramic permanent magnets of relatively low field strength. A commercial system would involve subjecting these magnets to field strength of approximately ten thousand oersteds until saturation is achieved and then desaturating these magnets until optimum magnetization is achieved. These magnets are ring shaped and are placed over the tube which contains the accelerator. The construction is made of organic and inorganic materials having a sequence beginning with an organic material of low density for the top layer followed by a layer of inorganic material of a higher density than the first layer, followed by another layer of inorganic material having a still higher overall density. This type of construction produces a type of storage battery for the quantum vacuum energy attracted by the construction and the particle accelerator. The reason for this is that materials of low density have low energy absorption but, high energy release capacity, while materials of medium density have higher energy absorption but, lower energy release capacity and materials of high density have still greater energy absorption but, even lower energy release capacity. Therefore, most of the energy absorbed by the high density layers will be retained by the layer unless a resonance force superior to that of the system is applied to the lower surface of the high density layer. When this occurs, energy stored in the high density layer will leave the system in the direction of the applied superior resonance force. In a suitable commercial system the flow of energy leaving the system would be balanced by energy attracted to and stored by the system. The arrangement of these magnetic plates allows for the energy attracted and stored in the high density layer of the upper plate to be passed to the high density layer of the second plate and from there to the high density layer of the final plate with this process continuing until saturation of all plates has occurred.

In order to allow for the discharge of the energy stored in the high density layer, the previously described sequence of materials is reversed with an inorganic material having a lower density than the high density layer being placed on the bottom of the high density layer, followed by a layer of organic material of still low density. The next layer would be the inorganic metal of which the hood of the vehicle is composed, which is very dense when compared with the organic layer which touches it. The final layer of the system, in effect, would be the air within the engine compartment which is of very low density when compared with that of the vehicle hood. With respect to the high density inorganic layer, this serves as a type of battery for the storage of energy from the quantum vacuum field previously stated before. This energy is released into the engine compartment by way of the low density organic layer which forms the second layer of the lower construction. This arrangement of materials produces a harmonic which coincides with a certain range of the quantum vacuum spectrum and allows for the exponential attraction of significant amounts of the energy into the confines of the engine compartment. This energy is subsequently utilized by the engine as an additional fuel source.

The prototype device includes a circular center section having overall dimensions of approximately 25.00 cm in diameter and a height of approximately 8.50 cm. This center construction is centered on top of another circular base section having overall dimensions of approximately 40.00 cm in diameter and a thickness of approximately 2.50 cm. The construction sequence is described as follows.

The particle accelerator is placed into an approximate 6.35 centimeter diameter PVC tube having an approximate height of 6.00 cm. This tube is centered on a circular, bottom construction made of alternating layers of organic and inorganic materials having the sequence of organic, inorganic and organic material. The organic layers may be of cardboard, Styrofoam or foam rubber having an approximate thickness of 5.00 mm. The inorganic layers are made of steel wool also having an approximate thickness of 5.00 mm. A total of three layers of organic material and two layers of inorganic material are used for an approximate total thickness of 2.50 cm. The diameter of this construction is approximately 25.00 cm and has an approximate thickness of 2.50 cm. On top of this construction is placed a PVC tube having an approximate diameter of 15.24 centimeters and an approximate height of 6.00 cm. Both the approximate 6.35 centimeter and the approximately 15.24 centimeter tubes are sealed with silicone at their respective points of contact with the upper surface of the circular, bottom construction mentioned before. After the approximate 6.35 centimeter and approximate 15.24 centimeter diameter PVC tubes have been sealed with silicone, the three circular hybrid ceramic permanent magnets are placed into the space between the tubes. These magnets are constructed of a mixture of plastic resin, steel wool and cast iron powder in accordance with the following sequence and method.

Two semi-circular sheet metal plates having a thickness of approximately 1 mm, a circumference of approximately 7.50 cm and a height of approximately 2.00 cm are installed around a suitable plastic container having a circular shape of sufficient size to allow for insertion into a space of approximately 15.24 cm and approximately 6.35 cm diameter tubes and connected to the signal transmitter with a coaxial cable of 50 ohms capacity. The metal plates are installed uniformly around the plastic container so that a space of approximately 16 centimeters between the terminations of the plates is provided. An approximately 1.00 cm layer of cast iron powder is placed uniformly into the bottom of the plastic container and a circular ring of steel wool having a thickness of approximately 0.50 cm is placed on top of the cast iron powder. Plastic resin is poured into the space to a height of approximately 2.00 cm. The signal transmitter is activated in order to allow for the plastic resin mix to become conditioned to the frequency of oscillation being utilized. The signal transmitter is allowed to remain active until the plastic resin mix has become completely cured and has cooled to room temperature. The above sequence is repeated for a total of two times to allow for the formation of the three discs having a total height of approximately 6.00 cm. The subjecting of these layers to the magnetic field produced by the metal plates serves to transform the layers into a type of hybrid ceramic permanent magnet of relatively low field strength. The transformed layers serve as a passive particle accelerator whose effectiveness is enhanced by the active particle accelerator located at the center of the layers. The now completed hybrid ceramic permanent magnets are placed into the center section and the two circular metal plates are installed around the approximately 15.24 centimeter diameter PVC tube and are secured into place with suitable plastic tape. The positive and negative connections of the particle accelerator are connected to the two sheet metal plates having dimensions of approximately 7.50 centimeters in circumference and approximately 6.00 centimeters in height.

After the circular hybrid ceramic permanent magnets have been placed into the structure, the approximately 2.50 cm space at the top of the construction is filled in accordance with the following sequence. A circular layer of cardboard, Styrofoam or foam rubber having an approximate thickness of 5.00 mm and an approximate diameter of 15.60 cm is placed into the construction. A circular layer of steel wool having a thickness of approximately 5.00 mm and an approximate diameter of 15.60 cm is placed into the construction. A circular layer of cardboard, Styrofoam, or foam rubber having an approximate thickness of 5.00 mm and an approximate diameter of 15.60 cm is placed into the construction. A circular layer of steel wool having a thickness of approximately 5.00 mm and an approximate diameter of 15.60 cm is placed into the construction. A circular layer of cardboard, Styrofoam or foam rubber having an approximate thickness of 5.00 mm and an approximate diameter of 15.60 cm is placed into the construction. The approximate 15.24 centimeter PVC tube is wrapped with a series of organic and inorganic materials in accordance with the following. A layer of steel wool having an approximate thickness of 5.00 mm and a height of approximately 10.50 cm is wrapped around the tube and secured into position with plastic tape. A layer of cardboard, Styrofoam or foam rubber having a thickness of approximately 5.00 mm and a height of approximately 10.50 cm is wrapped around the tube and secured into position with plastic tape. A layer of steel wool having an approximate thickness of 5.00 mm and a height of approximately 10.50 cm is wrapped around the tube and secured into position with plastic tape. A layer of cardboard, Styrofoam or foam rubber having a thickness of approximately 5.00 mm and an approximate height of 10.50 cm is wrapped around the tube and is secured into position with plastic tape. A layer of steel wool having an approximate thickness of 5.00 mm and an approximate height of 10.50 cm is wrapped around the tube and secured into position with plastic tape. A layer of cardboard, Styrofoam or foam rubber having a thickness of approximately 5.00 mm and a height of approximately 10.50 cm is wrapped around the tube and secured into position with plastic tape. A layer of steel wool having an approximate thickness of 5.00 mm and an approximately height of 10.50 cm is wrapped around the tube and is secured into position with plastic tape. A layer of cardboard, Styrofoam or foam rubber having a thickness of approximately 5.00 mm and a height of approximately 10.50 cm is wrapped around the tube and secured into position with plastic tape. A layer of steel wool having an approximate thickness of 5.00 mm and an approximate height of 10.50 cm is wrapped around the tube and secured into position with plastic tape. A layer of cardboard, Styrofoam or foam rubber having an approximate thickness of 5.00 mm and a height of 10.50 cm is wrapped around the tube and secured into position with plastic tape.

The construction also includes a circular geometry having an approximate diameter of 40.00 cm and an approximate thickness of 2.50 cm. The construction includes a series of organic and inorganic materials having the following sequence. The top layer of the construction includes a layer of organic material having an approximate thickness of 5.00 mm and having a shape which conforms to the structure of the center construction described above. This material may be any flexible material such as rubber or plastic. The next layer includes a layer of steel wool having a thickness of approximately 5.00 mm. The next layer includes a layer of the same organic material as the first layer and also having a thickness of approximately 5.00 mm. The next layer includes a layer of steel wool having a thickness of approximately 5.00 mm. The next layer includes a layer of the same organic material as the first layer and also having a thickness of approximately 5.00 mm.

To complete the assembly of the system, the center construction is placed on the base construction in such a manner that the center construction is centered on the base construction. After this has been performed a PVC mold, having the same exterior dimensions as the now assembled center and bottom constructions, is placed over the assembly and the now completed mechanism is attached to the hood of the vehicle with a fastener such as a bolt. In the case of installation on electric motors, the assembled PEAM is attached to the motor through the application of suitable conductive glue. The bottom section would be modified to conform to the surface of the motor. Experimental evidence has shown that any arrangement of organic and then inorganic materials which is installed around and above an interior and open space will attract energy from the quantum vacuum. The experimental evidence has also shown that if an arrangement is composed of a sequence of less dense, denser, very dense and less dense material then the attraction effect will be exponential in nature. The effectiveness of the combinations of these two systems is demonstrated by the field testing reports of the prototype of this system which is subsequently described.

In the passive mechanism design the transmitter activated particle accelerator is replaced with one based on permanent magnets fabricated with the frequency of oscillation utilized, thereby eliminating the transmitter. The sheet metal plates would also be eliminated in this passive design. Although a prototype of this passive design has not been constructed and tested, the efficiency of this design in terms of energy flow from the quantum vacuum would be the same as that of the active design. The advantages of this passive design would be reduced cost, greater ease of construction and installation and increased useful life of the system. The construction method for this design is the same as for the active design with the exception being that no electronics or electrical connections are utilized.

In the active/passive mechanism design a transmitter activated particle accelerator is placed in the center of the construction and two passive particle accelerators are placed on either side of the active accelerator. The construction method for this design is the same as for the active and passive designs. The advantage of this design is increased quantum vacuum energy flow due to increased resonance activity which translates into increased density.

### Prototype Field Testing Data

Internal Combustion Engine

Stationary Fuel Consumption without system attached.

| | Total Hours | Fuel | Rate of Fuel |
|---|---|---|---|
| Vehicle Type | of Operation | Consumed | Consumption |
| Dodge Polara | 2 | 3.022 Lts. | 1.511 Lts/Hr |
| 1982, 1800cc engine | | | |

Stationary Fuel Consumption with system attached.

| | Total Hours | Fuel | Rate of Fuel |
|---|---|---|---|
| Vehicle Type | of Operation | Consumed | Consumption |
| Dodge Polara | 11.04 | 7.20 Lts. | 0.652 Lts/Hr |
| 1982, 1800cc engine | | | |

From these results it can be seen that fuel consumption, in the stationary mode and at an idle speed of approximately 500 RPM, was improved by approximately 56.85 percent with the mechanism attached. During this testing the average time required for complete energy discharge of the prototype system was approximately 2.023 minutes during which time no fuel consumption occurred. The average time required for the recharging of the system was approximately 15.32 seconds during which time an average of approximately 25 milliliters of fuel was consumed for an average consumption of approximately 0.652 liters per hour. As the average fuel consumption without the system was approximately 1.511 liters per hour, the system delivers an average of approximately 29,855 kilojoules of energy per hour to the engine. This surplus energy is a combination of the energy obtained from the quantum vacuum and additional energy obtained from the fossil fuel being utilized due to molecular reorganization and more thorough mixing with air.

Results from over road testing of the system on a 1982 Dodge Polara sedan:

Fuel Consumption without system attached:

| | Total Distance | Fuel | Rate of Fuel |
|---|---|---|---|
| Vehicle Type | Traveled | Consumed | Consumption |
| Dodge Polara | 245 | 25.52 Lts. | 10.41 Lts/100 Km |
| 1982, 1800cc engine | | | |

Fuel Consumption with system attached:

| | Total Distance | Fuel | Rate of Fuel |
|---|---|---|---|
| Vehicle Type | Traveled | Consumed | Consumption |
| Dodge Polara | 243 | 11.23 Lts. | 4.62 Lts/100 Km |
| 1982, 1800cc engine | | | |

From these results it can be seen that fuel consumption for highway driving was improved by 55.62 percent with the mechanism attached. Average values of exhaust gas were measured by the Cartex COD001 system.

| Gas Components | Without System | With System |
|---|---|---|
| Hydrocarbons (ppm) | 648 | 434 |
| Carbon monoxide (%) | 6.17 | 0.57 |
| Carbon dioxide (%) | 9.20 | 13.18 |
| Oxygen (%) | 1.27 | 3.84 |

From these results it can be seen that hydrocarbon and carbon monoxide emissions were reduced by approximately 33.02 and approximately 90.76 percent respectively as a result of a more complete combustion of fuel along with the use of the energy contained in the quantum vacuum due to the attachment of the system. Carbon dioxide emissions increased by approximately 30.2 percent due mainly to the significant decrease in carbon monoxide but, also due to a reduced demand for oxygen by the engine as indicated by the approximate 66.93 percent increase in oxygen emission with the system attached. This indicates that the engine is partially using the energy contained in the quantum vacuum in place of oxygen in order to achieve combustion. It is believed that a commercial level system will not only achieve even greater improvements in fuel economy, than that of the prototype, but also significantly reduce all toxic gas emissions.

Electric Motor

In order to demonstrate the effectiveness of the primary energy absorption mechanism when installed on electric motors, a Mitsubishi 3.5 horsepower electric motor was connected to a Sawajuji model E2000ES electrical generator having a 2 KVa output rating. Both the motor and the generator were connected to instruments for measuring the voltage and amperage in order to accurately determine both input and output in watts. The purpose of this test was to demonstrate a reduction of input power requirements while producing an increase in output power. The control test of this system without the PEAM installed indicated that the consumption of the motor exceeded the output of the generator by approximately 73 per cent. The following table shows the first results of this testing.

| | | Control/ | | | | Control/ |
|---|---|---|---|---|---|---|
| | Output | Actual | Input | | Input | Actual |
| Time | Watts | % Diff. | Volts | Input Amps | Watts | % Diff. |
| 16:00 | 95.2 | 0 | 115 | 1.8 | 207 | 0 |
| 16:15 | 99.9 | 4.70 | 115 | 1.5 | 172.5 | 16,667 |
| 16:30 | 99.6 | 4,418 | 118 | 1.5 | 177 | 14,493 |
| 17:00 | 110.9 | 14.16 | 117.9 | 1.5 | 176.85 | 14,565 |
| 17:30 | 111.3 | 14.47 | 118.7 | 1.0 | 118.7 | 42,657 |
| 18:00 | 107.1 | 11.11 | 114.6 | 1.0 | 114.6 | 44,638 |
| 18.20 | 109.6 | 13.14 | 114.9 | 1.0 | 114.9 | 44,493 |
| 18:30 | 107.0 | 11.03 | 114.5 | 1.0 | 114.5 | 44,686 |
| 19:00 | 109.6 | 13.14 | 106.4 | 1.0 | 106.4 | 48,599 |
| 19:30 | 108.9 | 12.58 | 116.3 | 1.0 | 116.3 | 43,816 |
| 20:00 | 110.50 | 13,846 | 117.2 | 0.9 | 105.48 | 49,043 |

From these first results it can be seen that output power was increased by approximately 13.846 per cent and input power was reduced by approximately 49.043 per cent over a four hour period of time. It can also be noted that of the eleven data points, points number nine and eleven showed that output power exceeded than of input power by approximately 2.92 and approximately 4.543 per cent respectively.

After these results it was determined that the PEAM system would be more effective for the generation of electric power if a second unit was installed on the generator and a load was applied to the system. Therefore, a second PEAM unit was installed on the motor and generator and connected in series to the transmitter. The loading of the system was accomplished through the illumination of a series of 100 watt light bulbs connected together in parallel.

The following table shows the results of this second testing:

| Load | Motor | | | Generator | | |
|---|---|---|---|---|---|---|
| Watts | Volts | Amps | Watts | Volts | Amps | Watts |
| 100 | 119.2 | 3.12 | 371.9 | 210 | 0.45 | 94.5 |
| 200 | 117.9 | 3.72 | 438.59 | 204.2 | 0.9 | 183.78 |
| 400 | 116.1 | 4.93 | 572.37 | 193.8 | 2.0 | 387.6 |
| 800 | 112.9 | 7.08 | 799.33 | 172.9 | 4.29 | 741.74 |
| 1000 | 111.4 | 7.85 | 874.49 | 158.50 | 5.89 | 933.56 |
| 1500 | 109.3 | 8.85 | 967.31 | 128.2 | 10.1 | 1294.82 |

### Summary of Results

| | Motor/Gen. | Motor/Load | Gen./Load |
|---|---|---|---|
| Load | % Diff. | % Diff. | % Diff. |
| 100 | 74.59 | 73.11 | 5.5 |
| 200 | 58.098 | 54.40 | 8.11 |
| 400 | 32.282 | 30.115 | 3.1 |
| 800 | 7.205 | 0.084 | 7.283 |
| 1000 | 6.327 | 12.551 | 6.644 |
| 1500 | 25.294 | 35.513 | 13.679 |

From these results it can be seen that the input power of the motor was exceeded by the output of the generator by approximately 25.294 per cent. It can also be seen that the difference between the input power of the motor and the load placed on the system finalized with an approximate 35.513 per cent difference in favour of the load. However, the approximate negative 13.679 per cent difference between the output of the generator and the load placed on the system indicates a load measurement error of the same value. It is believed that this is due to the energy of the quantum vacuum taking the path of least resistance to the load and travelling around the transmission wire to the load instead of within the wire. In order to confirm the validity of this hypothesis, a photometer was used to measure the luminosity of the first one bulb and then five bulbs. Control measurements were first obtained through the use of an instrument known as a Variac in order to obtain the same number of watts for one bulb and then five bulbs measured with the system. The values thus obtained were then compared with the values noted with the system. The results of this comparison are given below.

Luminosity Test

| No. Bulbs | Control | System | % Difference |
|---|---|---|---|
| 1 | 86 | 89 | 3.37 |
| 5 | 76 | 83 | 8.43 |

From these results it can be seen that the luminosity measured with the system was significantly greater than that measured without the system. This provides proof that the above mentioned hypothesis is correct and that there is more energy being produced by the system that can be measured normally. This is due to the primordial nature of the energy of the quantum vacuum which prevents detection. There as yet exists no way to detect this energy as it must first be made to entangle with itself or something else with the entanglement being still beyond the reach of science.

As this testing indicated that an isolated system situation had been produced, the system was reorganized to include two 12 volt, 60 ampere batteries as a power source which was connected to a transformer to elevate the voltage to 110 volts in order to meet the requirements of the 3.5 horsepower DC electric motor. A circuit of specific design was connected to the generator in order to keep the batteries continuously recharged and the system was subjected to a continuous load of 2000 watts through the illumination of a total of twenty, one hundred watt light bulbs. The charge of the battery was continuously monitored through the use of a standard battery gauge. The result of this test was that the system ran for a period of 48 hours with no evidence that the batteries were losing charge. In order to demonstrate that the system will supply torque as well as power, a second test was performed with the system connected to a one horsepower electric water pump manufactured by Powermag of Germany. The results of this test were that the pump functioned at apparent full power for a total of 48 hours with no evidence that the batteries were losing charge.

This provides conclusive proof that the PEAM system may be applied to electric motors or a combination of an electric motor and a generator with a power source of a single battery which is continuously recharged by the system. From these results of the field testing of the prototype it is evident that the viability of the technology of the disclosed invention has been confirmed. The disclosed invention is not in violation of the second law of thermodynamics as energy from the quantum or zero point field continuously enters the invention. This is obviously true as if it were not, then the prototype of the disclosed invention would not be able to function as it does.

The use of the disclosed system will serve to favorably impact the environment through the reduction of toxic gas emissions and by allowing any internal combustion engine or electric motor to absorb and use the energy which it attracts from the quantum vacuum instead of permitting the energy to be absorbed by the earth. This latter point is important as excessive energy absorption by the earth could possibly provoke adverse changes in the climate such as earthquake and volcanic or severe atmospheric disturbance activity.

A signal transmitter having a frequency in the range of approximately 20 MHz to 300 MHz and a signal amplification in the range of approximately 2 to 10,000 watts transmitted in a pulsed sine or square wave can be utilized with this system to extract energy from the quantum vacuum field. A transmission sequence of approximately 5 milliseconds signal on and approximately 5 milliseconds off or any suitable time period of up to 100 milliseconds, can be used with the signal transmitter.

A plurality of frequency ranges can be utilized with the system selected from the group of consisting of approximately 35.356 kilohertz to 42.426 kilohertz, 22.95 Megahertz to 31.05 Megahertz, 1.037 Megahertz to 1.379 Megahertz, 996.561 Megahertz to 1.132 Gigahertz and 250 Terahertz to 430 Terahertz to extract energy from the quantum vacuum.

The frequency ranges of the Zero Point to extract quantum energy in commercial quantities include the frequency range of 35.356 Kilohertz to 1.379 Megahertz and 22.65 Megahertz to 430.00 Terahertz along with all harmonics thereof in the Hertz, Kilohertz, Megahertz, Gigahertz or Terahertz range when used with the disclosed invention or any other system for the purpose of the extraction of energy from the Quantum Vacuum.

FIG. 1C illustrates a side perspective view of a wiring diagram 170 of a system 100 to improve fuel economy, in accordance with one embodiment of the present invention.

The wiring diagram 170 includes the metal plates 150, the linear particle accelerator 160, the signal transmitter 162, a battery 172, a plurality of electromagnetic fields 180 and a plurality of wiring or circuitry 190. Elements of the metal plates 150, the linear particle accelerator 160 and the signal transmitter 162 are the same as previously described in FIGS. 1A and 1B. The battery 172 is in communication with the transmitter 162 which is in communication with the linear particle accelerator 160. The electromagnetic fields 180 are produced by the metal plates 150 which serve to transform the hybrid ceramic magnets 140 of relatively low field strength. The wiring or circuitry 190 provides electrical communication between the battery 172, the transmitter 162 and the linear particle accelerator 160.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to improve fuel economy of a vehicle with an internal combustion engine, comprising:
a base;
a primary energy absorption mechanism with a center or a core, a circular top and a cylindrical wall to attract and store energy contained in a quantum vacuum;
a plurality of fasteners that are utilized to removably secure said system to said vehicle hood;
a pair of hybrid ceramic magnets that are disposed within said primary energy absorption mechanism;
a pair of metal plates that are disposed between said cylindrical inner wall of said primary energy absorption mechanism and said hybrid ceramic magnets; and
a linear particle accelerator that has variable field strength and is positioned within said center of said primary energy absorption mechanism that includes a signal transmitter which is connected to said linear particle accelerator located within said core of said primary energy absorption mechanism.

2. The system according to claim 1, wherein said base is secured to said hood with said fasteners that are selected from the group of a removable screw, a removable bolt or a removable rivet.

3. The system according to claim 1, wherein said base is made of a sequential alternating layer of cardboard, styrofoam or foam rubber and steel wool.

4. The system according to claim 1, wherein said circular top and said cylindrical wall is made of a sequential alternating layer of cardboard, styrofoam or foam rubber and steel wool.

5. The system according to claim 1, wherein said hybrid ceramic magnets are made of a plurality of sequential alternating layers of plastic resin, steel wool and steel.

6. The system according to claim 1, wherein said metal plates coincide with a frequency of oscillation which corresponds with a particular range of a quantum vacuum energy spectrum.

7. The system according to claim 1, wherein said linear particle accelerator is made of a plurality of sequential alternating layers of wood and steel.

8. The system according to claim 1, wherein said signal transmitter has a transmission sequence of approximately 5 milliseconds signal on, approximately 5 milliseconds off, up to approximately 100 milliseconds to extract quantum energy from said quantum vacuum.

9. The system according to claim 1, wherein said system is placed on said hood of said vehicle.

10. The system according to claim 1, wherein said quantum vacuum energy is attracted and absorbed by said system in a plurality of combustion chambers of said internal combustion engine.

11. The system according to claim 1, wherein said system is utilized in a plurality of frequency ranges of Zero Point to extract said quantum energy that include 35.356 Kilohertz to 1.379 Megahertz and 22.65 Megahertz to 430.00 Terahertz and a plurality of harmonics in Hertz, Kilohertz, Megahertz, Gigahertz or Terahertz ranges to extract said quantum energy from said quantum vacuum.

12. A system to improve fuel economy of a vehicle with an electric engine, comprising:
a base;
a primary energy absorption mechanism with a center or a core, a circular top and a cylindrical wall to attract and store energy contained in a quantum vacuum;
a pair of hybrid ceramic magnets that are disposed within said primary energy absorption mechanism;
a pair of metal plates that are disposed between said cylindrical inner wall of said primary energy absorption mechanism and said hybrid ceramic magnets; and
a linear particle accelerator that is an active linear particle accelerator and a passive linear particle accelerator that has variable field strength and is positioned within said center of said primary energy absorption mechanism that includes a signal transmitter which is connected to said linear particle accelerator located within said core of said primary energy absorption mechanism, wherein said signal transmitter has a transmission sequence of approximately 5 milliseconds signal on, approximately 5 milliseconds off, up to approximately 100 milliseconds to extract quantum energy from said quantum vacuum.

13. The system according to claim 12, wherein said base is made of a sequential alternating layer of cardboard, Styrofoam or foam rubber and steel wool.

14. The system according to claim 12, wherein said circular top and said cylindrical wall is made of a sequential alternating layer of cardboard, styrofoam or foam rubber and steel wool.

15. The system according to claim 12, wherein said hybrid ceramic magnets are made of a plurality of sequential alternating layers of plastic resin, steel wool and steel powder.

16. The system according to claim 12, wherein said metal plates coincide with a frequency of oscillation which corresponds with a particular range of a quantum vacuum energy spectrum.

17. The system according to claim 12, wherein said linear particle accelerator is made of a plurality of sequential alternating layers of wood and steel powder.

18. The system according to claim 12, wherein said system is secured on said electrical engine with a conductive glue or a plurality of removable fasteners.

19. The system according to claim 12, wherein said quantum vacuum energy is attracted and absorbed by said system in a plurality of combustion chambers of said internal combustion engine.

20. The system according to claim 12, wherein said system is utilized in a plurality of frequency ranges of Zero Point to extract said quantum energy from said quantum vacuum that include 35.356 Kilohertz to 1.379 Megahertz and 22.65 Megahertz to 430.00 Terahertz and a plurality of harmonics in Hertz, Kilohertz, Megahertz, Gigahertz or Terahertz ranges.
